(19) United States
(12) Patent Application Publication
(10) Pub. No.: US 2026/0067957 A1
(43) Pub. Date: Mar. 5, 2026

(54) METHODS, ARCHITECTURES, APPARATUSES AND SYSTEMS FOR CONGESTION CONTROL IN MULTIPATH SIDELINK RELAYING

(71) Applicant: InterDigital Patent Holdings, Inc., Wilmington, DE (US)

(72) Inventors: Martino Freda, Laval (CA); Tuong Hoang, Montreal (CA); Oumer Teyeb, Montreal (CA); Ananth Kini, Conshohocken, PA (US)

(21) Appl. No.: 18/881,052

(22) PCT Filed: Jun. 30, 2023
(86) PCT No.: PCT/US2023/026749

§ 371 Date: Jan. 3, 2025

Related U.S. Application Data
(60) Provisional application No. 63/358,586, filed on Jul. 6, 2022.

(51) Int. Cl. H04W 76/14; H04W 88/04

(52) U.S. Cl. CPC H04W 76/14; H04W 88/04

(57) ABSTRACT

Procedures, methods, architectures, apparatuses, systems, devices, and computer program products directed to congestion control in multipath sidelink relaying are described herein. According to an embodiment, a method implemented in a wireless transmit/receive unit (WTRU) includes transmitting data for a split bearer associated with a link to a base station and a sidelink to a relay WTRU. The data may comprise first data that may be transmitted over the sidelink using a first set of congestion control parameters. The method may include determining that a quality deterioration occurred on the link to the base station. The method may include transmitting further data for the split bearer. In various embodiments, the further data may include second data that may be transmitted via the sidelink using a second set of congestion control parameters based on the determining that a quality deterioration occurred on the link to the base station.

### CROSS-REFERENCE TO RELATED APPLICATIONS

This application claims the benefit of U.S. Patent Application No. 63/358,586 filed Jul. 6, 2022, which is incorporated herein by reference in its entirety.

### TECHNICAL FIELD

The present disclosure is generally directed to the fields of communications, software and encoding, including, for example, to methods, architectures, apparatuses, systems directed to congestion control in multipath sidelink relaying.

### BACKGROUND

Sidelink (SL) relaying was introduced in third generation partnership project (3GPP) release 17 to extend the network coverage. For example, wireless transmit/receive unit (WTRU) to network relays may be used for that purpose.

### BRIEF SUMMARY

Methods, architectures, apparatuses, and systems directed to congestion control in multipath sidelink relaying are described herein. In an embodiment, a method implemented in a WTRU is described herein. The method may include transmitting data for a split bearer associated with a link to a base station and a sidelink to a relay WTRU. In various embodiments, the data may comprise first data that may be transmitted via the sidelink using a first set of congestion control parameters. The method may include determining that a quality deterioration occurred on the link to the base station. The method may include transmitting further data for the split bearer. In various embodiments, the further data may include second data that may be transmitted via the sidelink using a second set of congestion control parameters based on the determining that a quality deterioration occurred on the link to the base station.

In an embodiment, a WTRU including a processor and a transmitter and a receiver (e.g., a transceiver) operatively coupled to the processor is described herein. The WTRU may be configured to transmit data for a split bearer associated with a link to a base station and a sidelink to a relay WTRU. In various embodiments, the data may comprise first data that may be transmitted via the sidelink using a first set of congestion control parameters. The WTRU may be configured to determine that a quality deterioration occurred on the link to the base station. The WTRU may be configured to transmit further data for the split bearer. In various embodiments, the further data may comprise second data that may be transmitted via the sidelink using a second set of congestion control parameters based on the determining that a quality deterioration occurred on the link to the base station. In various embodiments, the second data may be associated with a second grant for second sidelink transmissions, and the second sidelink transmissions associated with the second grant may be restricted to transmissions of a second group of logical channels associated with the second set of congestion control parameters.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example of user plane protocol stack for layer-2 (L2) WTRU-to-network (U2N) relaying;

FIG. 3 is a system diagram illustrating an example of control plane protocol stack for L2 U2N relaying;

FIG. 4 is a diagram illustrating an example method for congestion control in multipath sidelink relaying;

FIG. 5 is a diagram illustrating an example method for congestion control in multipath sidelink relaying;

FIG. 6 is a diagram illustrating an example method for SL channel busy ratio (CBR) reporting; and

FIG. 7 is a diagram illustrating an example method for changing a set of congestion control parameters based on receiving multipath information.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

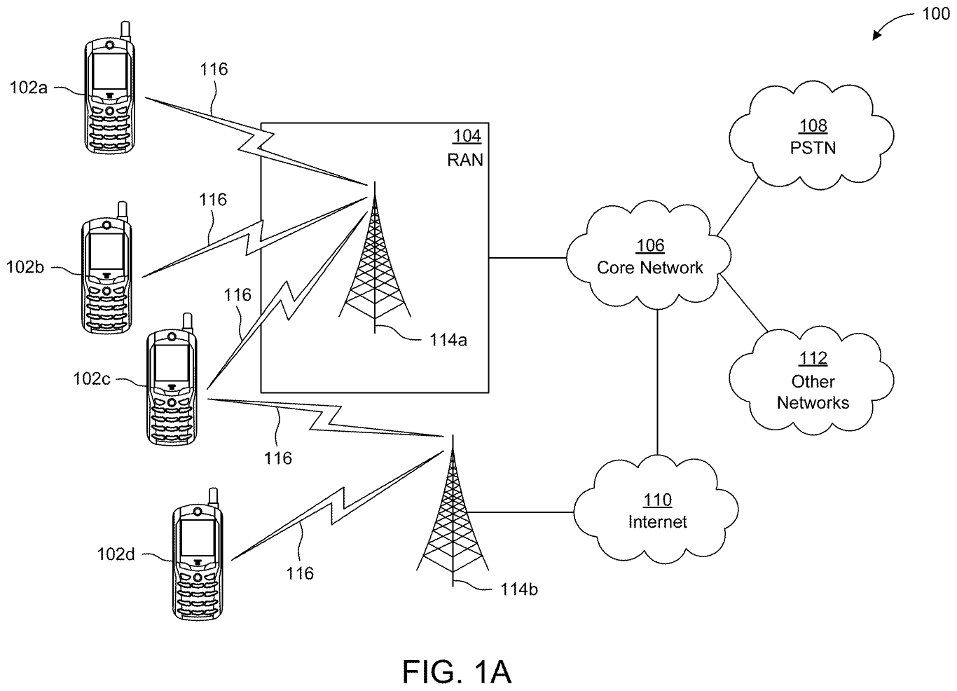

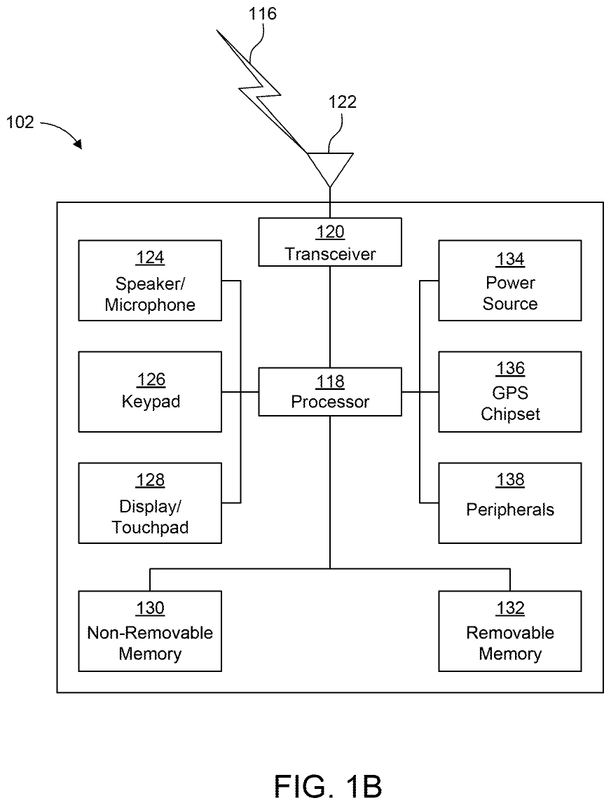

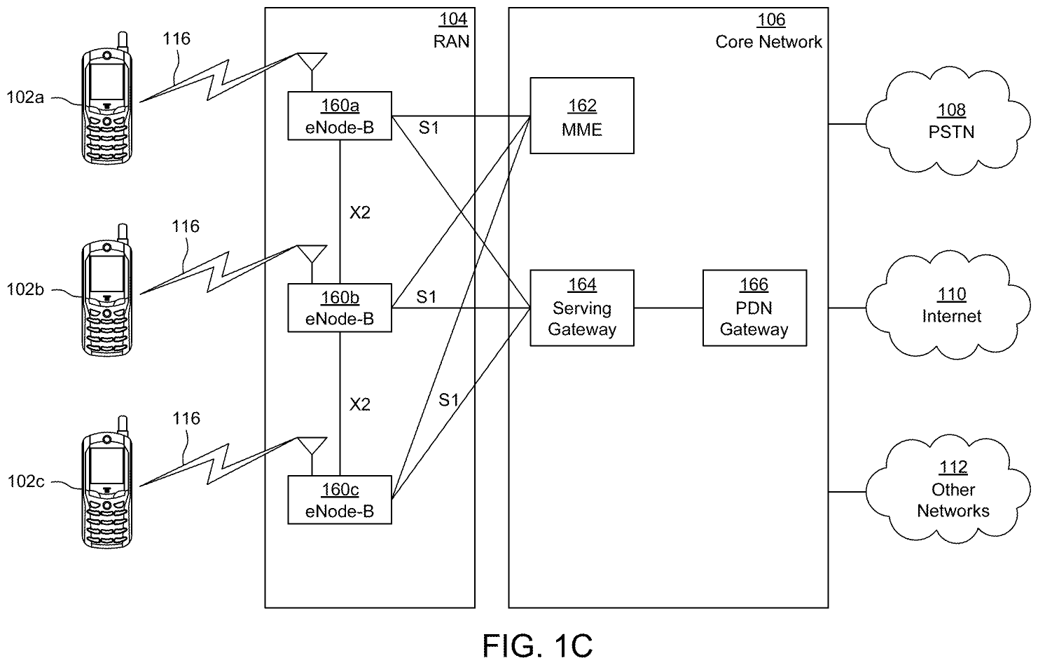

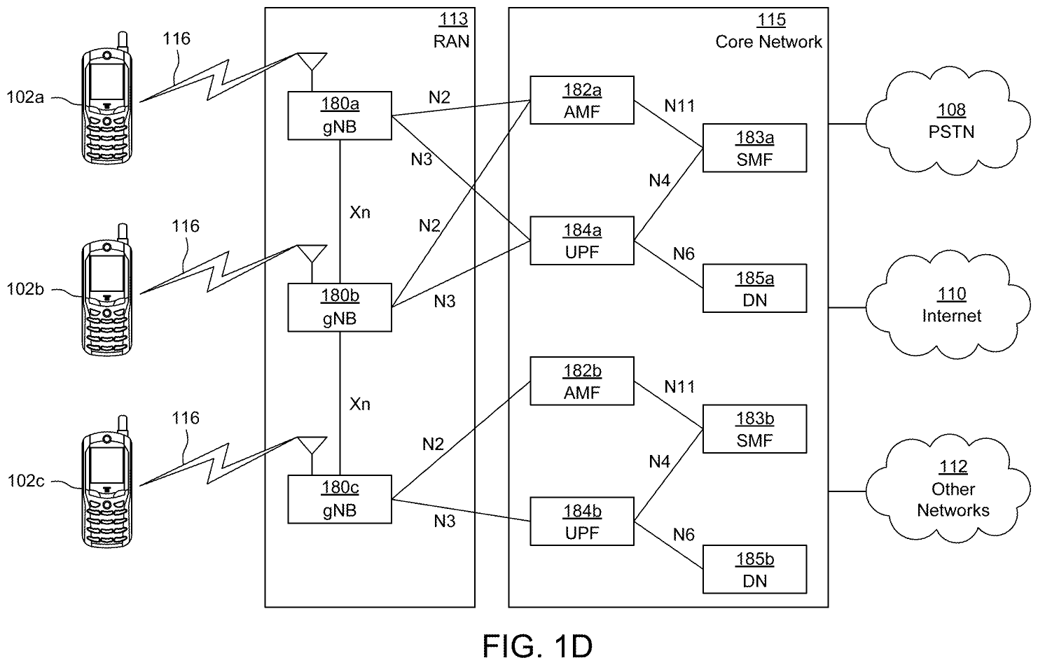

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184band an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “serving base station”, “base station”, “gNB”, “network” collectively “the network” may be used interchangeably to designate any network element such as e.g., a network element acting as a serving base station. Embodiments described herein are not limited to gNBs and are applicable to any other type of serving base stations.

For the sake of clarity, satisfying, failing to satisfy a condition and configuring condition parameter(s) are described throughout embodiments described herein as relative to a threshold (e.g., greater or lower than) a (e.g., threshold) value, configuring the (e.g., threshold) value, etc. For example, satisfying a condition may be described as being above a (e.g., threshold) value, and failing to satisfy a condition (e.g., performance criteria) may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report measurement(s)”, “the WTRU may determine to report measurement(s)”, and “the WTRU may be configured to report measurement(s)”, is equivalent or may be used interchangeably with “the WTRU may transmit (e.g., reporting) information indicating measurement(s)”.

In embodiments described herein the term Uu is used to refer to any of data, transmission, interface, characteristic etc., associated with the (up/down) link to the base station.

3GPP release 17 introduced SL-based WTRU to network relays, which may be referred to herein as U2N relay WTRUs. Sidelink (SL) relay was introduced to support 5G proximity based (ProSe) WTRU-to-network relay (U2N relay) function to provide connectivity to the network for (e.g., remote) WTRUs, which may be referred herein as U2N remote WTRUs. In 3GPP release 17, any of layer-2 (L2) and layer-3 (L3) U2N relay architectures may be supported. The L3 U2N relay architecture may be transparent to the serving RAN of the U2N relay WTRU, except for controlling sidelink resources.

Throughout embodiments described herein the terms “U2N remote WTRU”, “remote WTRU”, and “WTRU”, collectively “remote WTRU” may be used interchangeably to designate any WTRU connected to the network via a relay WTRU. Throughout embodiments described herein the terms “U2N relay WTRU”, “relay WTRU”, and “WTRU”, collectively “relay WTRU” may be used interchangeably to designate any WTRU capable of relaying data between a remote WTRU and the network.

For example, a U2N relay WTRU may be in a connected state (such as e.g., RRC CONNECTED) to perform relaying of unicast data.

For L2 U2N relay operation, the following (e.g., RRC) state combinations may be applicable. For example, a U2N relay WTRU and a U2N remote WTRU may be in a connected state (such as e.g., RRC CONNECTED) to perform any of transmission and reception of relayed unicast data. For example, a U2N relay WTRU may be in any of idle state (e.g., RRC_IDLE), inactive state (e.g., RRC_INACTIVE) and connected state (e.g., RRC_CONNECTED) in a case where (e.g., all) the U2N remote WTRUs that may be connected to the U2N relay WTRU are in any of inactive state (e.g., RRC_INACTIVE) and idle state (e.g., RRC_IDLE).

Two modes may be used for centralized and distributed scheduling of WTRU transmissions, which may be referred to herein as mode 1 and mode 2. Centralized scheduling (e.g., mode 1) may occur at the gNB (e.g., in-coverage mode), and distributed scheduling (e.g., mode 2) may be carried out by the WTRUs. In mode 1, the WTRUs may be scheduled by the gNB over dedicated radio resources for data transmission. In mode 2, a WTRU may autonomously select a radio resource from a resource pool, which may be any of configured by the network and pre-configured in the WTRU.

For example, for L2 U2N relay, a U2N remote WTRU may be configured to use resource allocation mode 2 for data to be relayed.

For example, a (e.g., single) unicast link may be established between one L2 U2N relay WTRU and one L2 U2N remote WTRU. For example, the traffic of a U2N remote WTRU via a U2N relay WTRU and the traffic of the U2N relay WTRU may be separated in different (e.g., Uu RLC) channels over Uu.

### Example of L2 U2N Relay Protocol Architecture

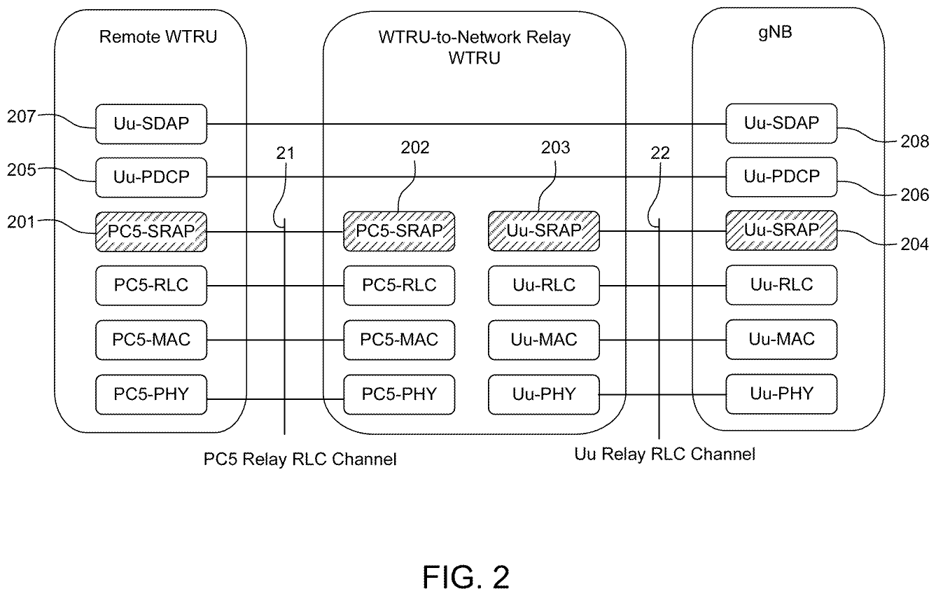

FIG. 2 is a system diagram illustrating an example of a user plane protocol stack for L2 U2N relaying.

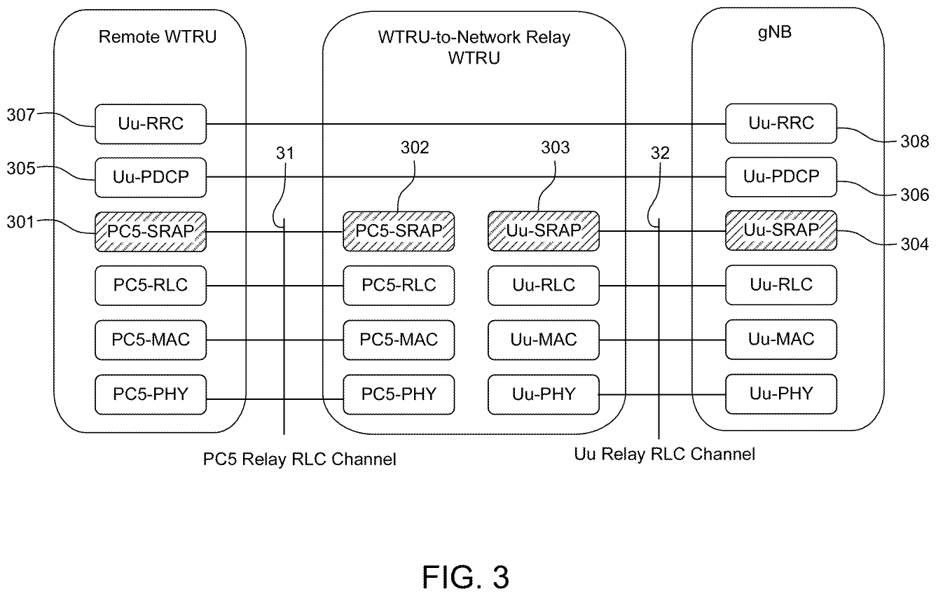

FIG. 3 is a system diagram illustrating an example of a control plane protocol stack for L2 U2N relaying.

As shown in FIG. 2 and FIG. 3; the sidelink relay adaptation protocol (SRAP) sublayer 201, 202, 203, 204, 301, 302, 303, 304 may be placed above the radio link control (RLC) sublayer for the control place (CP) and the user plane (UP) at the PC5 interface 21, 31 and the Uu interface 22, 32. The Uu service data adaptation protocol (SDAP) 207, 208, the packet data convergence protocol (PDCP) 205, 206, 305, 306 and the radio resource control (RRC) 307, 308 may be terminated between L2 U2N remote WTRU and the gNB. The SRAP, RLC, MAC and PHY may be terminated at each hop (e.g., the link between the L2 U2N remote WTRU and the L2 U2N relay WTRU and the link between the L2 U2N relay WTRU and the gNB).

For L2 U2N relay, the SRAP sublayer over PC5 (e.g., hop) may be used for bearer mapping. For example, the SRAP sublayer may not be present (e.g., not used) over PC5 (e.g., hop) for relaying messages(s) of the L2 U2N remote WTRU on any of the broadcast control channel (BCCH) and the physical control channel (PCCH). For example, for message(s) of a L2 U2N remote WTRU on signaling radio bearer 0 (SRB0), the SRAP sublayer may not present (e.g., not used) over PC5 (e.g., hop), and the SRAP sublayer may not be present (e.g., not used) over Uu (e.g., hop) for any of downlink (DL) and uplink (UL).

For L2 U2N relay, for uplink, the Uu SRAP sublayer may support (e.g., operate, apply) UL bearer mapping between ingress PC5 relay RLC channels for relaying and egress Uu relay RLC channels over the L2 U2N relay WTRU Uu interface. For uplink relaying traffic, the different end-to-end radio bearers (RBs), such as e.g., any of signaling radio bearers (SRBs) and data radio bearers (DRBs) of any of a same remote WTRU and different remote WTRUs may be multiplexed over a same Uu Relay RLC channel.

For uplink L2 U2N relay, the Uu SRAP sublayer may support (e.g., operate, apply) L2 U2N remote WTRU identification for the UL traffic. Information indicating the identity of L2 U2N remote WTRU Uu radio bearer and information indicating a local remote WTRU identifier (ID) may be included in the Uu SRAP header at UL in order for the gNB to correlate the received packets for the (e.g., specific) PDCP entity associated with a corresponding Uu radio bearer of a remote WTRU.

For uplink L2 U2N relay, the PC5 SRAP sublayer at the L2 U2N remote WTRU may support (e.g., operate, apply) UL bearer mapping between remote WTRU Uu radio bearers and egress PC5 relay RLC channels.

For L2 U2N relay, for downlink, the Uu SRAP sublayer may support (e.g., perform, apply) DL bearer mapping at gNB to map (e.g., associate) end-to-end radio bearer (SRB, DRB) of a remote WTRU into Uu relay RLC channel over the relay WTRU Uu interface. For example, the Uu SRAP sublayer may support (e.g., perform, apply) any of DL bearer mapping (e.g., association) and data multiplexing between multiple end-to-end radio bearers (SRBs or DRBs) of one or more L2 U2N remote WTRUs and one Uu Relay RLC channel over the relay WTRU Uu interface.

For downlink L2 U2N relay, the Uu SRAP sublayer may support remote WTRU identification for DL traffic. For example, any of information indicating the identity of a remote WTRU Uu radio bearer and information indicating a local remote WTRU identifier (ID) may be included into the Uu SRAP header by the gNB at DL such that the relay WTRU may map (e.g., associate) the received packets from the remote WTRU Uu radio bearer to its associated PC5 relay RLC channel.

For downlink L2 U2N relay, the PC5 SRAP sublayer at the relay WTRU may support (e.g., perform, apply) DL bearer mapping (e.g., association) between ingress Uu relay RLC channels and egress PC5 relay RLC channels.

For downlink L2 U2N relay, the PC5 SRAP sublayer at the remote WTRU may correlate the received packets for a (e.g., specific) PDCP entity associated with corresponding Uu radio bearer of a remote WTRU based on identity information, that may be included in the Uu SRAP header.

For example, a local remote WTRU ID may be included in any of the PC5 SRAP header and the Uu SRAP header. For example, a L2 U2N relay WTRU may be configured by the gNB with (e.g., may receive configuration information from the gNB indicating) the local remote WTRU ID to be used in SRAP header. For example, a remote WTRU may obtain (e.g., receive) information indicating the local remote ID from the gNB via any Uu RRC messages such as e.g., any of a RRCSetup message, a RRCReconfiguration message, a RRCResume message and a RRCReestablishment message. For example, any of Uu DRB(s) and Uu SRB(s) may be mapped to different PC5 Relay RLC channels and Uu Relay RLC channels in any of PC5 hop and Uu hop.

For example, the gNB may avoid collision on the usage of local remote WTRU IDs. The gNB may update a local remote WTRU ID by sending information indicating the updated local remote ID, for example in a (e.g., RRCReconfiguration) message to the relay WTRU. The serving gNB may perform local remote WTRU ID update independently from the PC5 unicast link L2 ID update procedure.

### Example of Multipath

Release 17 of the 3GPP specifications introduced layer 2 WTRU to network relays, for addressing remote WTRU out of coverage situations. In release 18, multipath may be addressed. In multipath, a remote WTRU may be (e.g., assumed to be) in coverage and may use any combination of a Uu path and SL (relayed) path(s). For example, multipath may allow to enhance reliability and throughput (e.g., by any of switching among and utilizing the multiple paths simultaneously). For example, a WTRU may be connected to the same gNB using one direct path and one indirect path via any of a L2 U2N relay and another WTRU.

### Example of Congestion Control in SL

SL channel busy ratio (CBR) may be a physical layer measurement that may be used in SL to manage SL resource congestion. Throughout embodiments described herein SL CBR and CBR may be used interchangeably to refer to sidelink channel busy ratio. In mode 2 (WTRU autonomous) scheduling mode, the WTRU may perform measurements of CBR. In mode 2 scheduling mode, the WTRU may be configured with (e.g., maximum) values of transmission parameters (e.g., any of modulation and coding scheme (MCS), Tx power, maximum number of selected subchannels) and a channel occupancy ratio (CR) that may be used for transmissions associated with a (e.g., specific) priority. For example, different sets (e.g., each set) of parameters may be configured for a different range of measured CBR at the WTRU. In mode 1 scheduling mode, the WTRU may be configured to report information indicating CBR measurements to the network, and the network may use the reported CBR measurements to allocate an appropriate amount of SL resources for mode 1.

### Overview

Congestion control may be used to control congestion of SL resources in a case where mode 2 is used. In multipath, for example, duplication may be used to increase reliability of transmissions, and congestion control on SL may compromise the QoS guarantee (e.g., objective) of Uu traffic that may be subject to higher reliability expectations. For example, the gNB may configure congestion control parameters to a WTRU in multipath under the assumption that the direct Uu path may operate correctly (e.g., in normal conditions). Embodiments described herein may allow to revisit (e.g., update) congestion control (e.g., policies, parameters) such that the congestion control may not impact (e.g., affect) the reliability expectations (e.g., objectives) of Uu data being transmitted via a relay WTRU, for example in the context of multipath transmissions and, for example, in a case where the Uu path is degraded.

In an embodiment, a remote WTRU may determine congestion control parameters on SL based on Uu channel conditions.

In an embodiment, a remote WTRU may be configured in multipath to transmit data for a split bearer via any of Uu (direct) and sidelink (indirect to a U2N relay).

In an embodiment, a remote WTRU may be configured with a first set of congestion control parameters (such as e.g., any of max SL power, maximum number of selected resources, etc.), and a second set of congestion control parameters. For example, the remote WTRU may transmit first data for a split bearer via a (e.g., first, direct) link to a base station and a (e.g., second) link (e.g., sidelink) to a relay WTRU, wherein the first data may be transmitted using a first congestion control operating mode (e.g., the first set of congestion control parameters).

In an embodiment, in a case where an event associated with Uu quality deterioration occurs (such as e.g., any of Uu radio link failure (RLF), number of Uu hybrid automatic repeat request (HARQ) errors, Uu listen before talk (LBT) failure), the remote WTRU may transmit second data for the split bearer using a second congestion control operating mode. For example, the second set of congestion control parameters may be used for transmissions associated with the SL logical channels (LCHs) mapped to (e.g., associated with) the split bearer.

Embodiments are described herein in a multipath example, in which a remote WTRU may any of transmit and receive over any of a first (e.g., direct, Uu) path and a second (e.g., indirect via a SL relay) path. Embodiments described herein may be also applicable to other multipath examples, where e.g., more than two paths may be used, such as e.g., any of multiple SL carriers, and examples where the remote WTRU and the relay WTRU may be connected by an ideal connection.

### Examples of Duplication Decision Depending on Measured Congestion

In an embodiment, a WTRU may determine whether to perform duplication of a protocol data unit (PDU) on multiple (e.g., more than one) paths based on the measured congestion of SL. For example, the WTRU may be configured with conditions for which duplication may be allowed, or not allowed (e.g., prevented). For example, the WTRU may be configured with conditions which may dictate (e.g., determine) when duplication may be to be performed or not performed. For example, the WTRU may receive configuration information indicating the conditions for which duplication may be allowed (e.g., performed) or not allowed (e.g., not performed, prevented). For example, the conditions for allowing (e.g., performing) duplication at a WTRU may further depend on other factors (e.g., parameters) as described herein, such as any of priority of data, configuration of the primary path of a bearer, etc.

In one example, a remote WTRU configured with multipath transmission for uplink, e.g., associated with a single bearer (such as e.g., a split bearer) may perform duplication in a case where the measured SL CBR fails to satisfy a channel occupancy condition (e.g., is below a threshold). Otherwise, e.g., in a case where the measured SL CBR satisfies a channel occupancy condition (e.g., is above a threshold), the WTRU may be prevented to duplicate PDUs (e.g., may disable PDU duplication) and may be allowed to transmit on one link e.g., only (Uu or SL).

In another example, the number of carriers on SL that may be used for duplication may be based (e.g., depend) on the measured CBR. For example, a WTRU may determine that the number of carriers that may be used for PDU duplication may be lower than or equal to (e.g., at most) a value X in a case where a channel occupancy condition is met. In a first example, the channel occupancy condition may be met, if the measured CBR is in given range of CBR values. In a second example, the channel occupancy condition may be met if the measured CBR is below a threshold.

In another example, a remote WTRU may perform duplication of data for a bearer based on a combination of SL CBR and which UL path(s) (e.g., any of direct path to the base station and indirect path via a relay) or which primary path(s) may be configured for the bearer. For example, the remote WTRU may use different (e.g., duplication) congestion control behaviors based on the SL CBR of the resource pool associated with any of the UL path(s) and the primary path that may be configured to the remote WTRU. For example, a WTRU may be configured with a primary path for the bearer, or with an UL path to be used (e.g., by default) for the bearer. For example, the primary path may be used by the WTRU to send some (e.g., all) SRB data. For example, the primary path for a bearer may be used by the WTRU to send UL data until a condition is satisfied (e.g., up to a (e.g., configured) buffer threshold amount), after which the WTRU may use the other path. For example, the UL path may be used by the WTRU to send (e.g., all) data for the (e.g., specified) DRB. For example, if the primary path for the bearer is SL, the remote WTRU may perform duplication without any consideration (e.g., independently) of any SL CBR. For example, if the primary path for the bearer is Uu, the remote WTRU may perform duplication in a case where the measured CBR satisfies a channel occupation condition (e.g., is below a threshold).

Embodiments are described herein with range and threshold-based conditions. Any other types of conditions may be applicable to embodiments described herein, such as, for example, any of thresholds and ranges further depending on the priority of the transmission. Such conditions (e.g., any of thresholds and ranges) may further be configured per split bearer on Uu, for example.

### Examples of Congestion Control Behavior at the Remote WTRU Depending on the Uu Characteristics

The expressions “operating with a (e.g., first, second) congestion control behavior”, “using a (e.g., first, second) congestion control behavior for transmission”, “transmitting using a (e.g., first, second) set of congestion control operating mode” and “transmitting using a (e.g., first, second) set of congestion control parameters” may be used interchangeably throughout embodiments described herein to describe different sets of parameters that may be used to operate different variations of congestion control over one or more links.

In an embodiment, a WTRU may determine its congestion control behavior (e.g., to be used via SL) based on one or more characteristics related to the Uu (direct) link (e.g., path), e.g., to the gNB. For example, the congestion control behavior determination may be made for one bearer (e.g., only). For example, after an event on the Uu link, the WTRU may change the congestion control behavior for a first or first set of LCHs, and the WTRU may not change the congestion control behavior for a second or second set of LCHs. For example, the congestion control behavior may be determined for a bearer configured with duplication. For example, a WTRU that may perform duplication, e.g., for a (e.g., specific) split bearer may determine its congestion control behavior based on one or more Uu characteristics (e.g., one or more characteristics of the link to the gNB).

Uu characteristics, based on which the WTRU may determine (e.g., update) its congestion control behavior (e.g., to be used via SL) may include any combination of the following examples.

For example, the Uu characteristics may include Uu measurements (e.g., measurements that may be performed on the Uu link to the gNB), such as any of Uu reference signal receive power (RSRP), channel quality indicator (CQI), etc. For example, a WTRU may operate with a first congestion control behavior (e.g., via SL) in a case where the Uu RSRP satisfies a power condition (e.g., is above a threshold), and may operate with a second congestion control behavior (e.g., via SL) in a case where the Uu RSRP fails to satisfy a power condition (e.g., is below a threshold).

For example, the Uu characteristics may include a Uu RLF determination. For example, a WTRU may operate with a first congestion control behavior (e.g., via SL) in a case where Uu RLF has not been triggered (e.g., detected), and may operate with a second congestion control behavior (e.g., via SL) after Uu RLF may be triggered (e.g., detected), and/or while Uu RLF may be pending.

For example, the Uu characteristics may include a beam failure detection (BFD). For example, a WTRU may operate with a first congestion control behavior (e.g., via SL) in a case where BFD has not been triggered (e.g., detected), and may operate with a second congestion control behavior (e.g., via SL) after BFD may have been triggered (e.g., detected) and/or while BFD may be pending.

For example, the Uu characteristics may include Uu HARQ feedback characteristics. For example, a WTRU may operate with a first congestion control behavior (e.g., via SL) in a case where the number of (e.g., consecutive) HARQ negative acknowledges (NACKs) received over Uu satisfies a condition (e.g., is below a threshold), and may operate with a second congestion control behavior (e.g., via SL) in a case where the number of (e.g., consecutive) HARQ NACKs received over Uu fails to satisfy the condition (e.g., is above a threshold).

For example, the Uu characteristics may include an unlicensed spectrum channel access failure (e.g., any of Uu LBT and access to unlicensed spectrum associated with Uu). For example, a WTRU may operate with a first congestion control behavior (e.g., via SL) in a case where the WTRU fails to succeed LBT (and/or in a case where the WTRU is unable to access the shared channel) and may operate with a second congestion control behavior (e.g., via SL) otherwise.

For example, the Uu characteristics may include a buffer status. For example, a WTRU may operate with a first congestion control behavior (e.g., via SL) in a case where the amount of data buffered at the WTRU (for example associated with one or more bearers) satisfy a filing condition (e.g., is above a threshold), and may operate with a second congestion control behavior (e.g., via SL) otherwise. The filing condition (e.g., the threshold) may be zero in one specific example.

For example, the Uu characteristics may include receiving any of explicit and implicit network signaling. For example, a WTRU may operate with a first congestion control behavior (e.g., via SL), and may operate with (e.g., initiate, start) a second congestion control behavior (e.g., via SL) after the reception of any of an explicit and implicit signaling from the network indicating to change the congestion control behavior. For example, the WTRU may receive explicit information such as e.g., an explicit indication to change the congestion control behavior. For example, any of a dedicated MAC control element (CE), downlink control information (DCI), a radio resource control (RRC) message, etc. received by the WTRU may indicate the WTRU to change from a first congestion control behavior to a second congestion control behavior. In another example, an implicit indication (e.g., message), may be received by the WTRU, which may include a scheduling grant (e.g., DCI), for example, with criteria (e.g., configured grant with specific value of new data indicator (NDI)).

For example, a WTRU operating with a first congestion control behavior (e.g., via SL) may transition (e.g., switch) to a second congestion control behavior (e.g., via SL) after occurrence of an (e.g., quality deterioration) event on Uu (e.g., RLF). After occurrence of the event, the WTRU may use the second congestion control behavior (e.g., via SL) until the reception of network signaling (such as e.g., reception of an RRC reconfiguration message), e.g., indicating reconfiguring the congestion control behavior associated with the first congestion control behavior).

For example, a relay WTRU may receive information from the network indicating that any of a PDU, a set of PDUs, and data associated with a LCH may be duplicated in the downlink. For example, a relay WTRU may receive information in a protocol header indicating that a PDU received at the relay may be duplicated by the network (e.g., also) on the Uu link. For example, a relay WTRU may receive information (such as e.g., a MAC CE) indicating that the network may have initiated duplication for one or more DL bearers over any of relayed and direct path. After receiving such indication, the relay WTRU may change to a second congestion control behavior for the duplicated data.

For example, the Uu characteristics may include a (e.g., configured amount of time (e.g., timer)). For example, a WTRU operating with a first congestion control behavior (e.g., via SL) may change to a second congestion control behavior (e.g., via SL) after any event described herein. For example, the WTRU start a timer and may maintain a second congestion control behavior until the timer may expire. After a determination that an amount of time has elapsed after starting to operate with the second congestion control behavior (e.g., upon expiry of the timer), the WTRU may switch back to the first congestion control behavior.

For example, the congestion control behavior may be based on the bearer(s) of which data may be contained in the SL transmission. For example, a WTRU may operate with a first congestion control behavior in a case where a SL transmission includes data from any of a first and a first set of bearers and may operate with a second congestion control behavior in a case where a SL transmission includes data from any of a second and a second set of bearers. For example, the WTRU may determine the bearers for which the second congestion control behavior may be used based on any of (1) an explicit configuration to allow such behavior, (2), whether the bearer is configured with duplication, (3) whether the bearer is configured with primary path on Uu or not, (4) the LCH priority configured for the bearer, (5) the packet delay budget (PDB) configured for the SL RLC bearer (e.g., in comparison to a condition such as e.g., threshold), and (6) the buffer status (e.g. at the time when a Uu event may allow the use of a second congestion control behavior, the WTRU may determine whether a bearer may use the second congestion control behavior based on its buffer status-e.g. amount of data above a threshold). For example, the WTRU may operate with a first congestion control behavior for SL data which may be directed (e.g., intended) to a SL WTRU, and a second congestion control behavior for SL data which may include relayed Uu data.

For example, the Uu characteristics may include whether a bearer is configured with duplication or not. For example, a WTRU may operate with a first congestion control behavior in a case where a SL transmission includes data from a bearer configured with duplication and may operate with a second congestion control behavior in a case where a SL transmission does not include data from a bearer configured with duplication (e.g., the SL transmission including data from a bearer for which duplication may be prevented).

For example, the Uu characteristics may include QoS parameter of the data to be transmitted. For example, a WTRU may operate with a first congestion control behavior in a case where the priority satisfies a priority condition (e.g., is above a threshold), and may operate with a second congestion control behavior in a case where the priority fails to satisfy the priority condition (e.g., is below a threshold). For example, a WTRU may operate with a second congestion control behavior for bearers on multipath configured with guaranteed bit rate (GBR) satisfying a bit rate condition (e.g., above a threshold).

For example, the Uu characteristics may include use of the exceptional resource pool. For example, a WTRU may initiate usage of the exceptional resource pool on SL. In a case where a WTRU configured with multipath initiates transmission over the exceptional resource pool on SL, the WTRU may initiate (e.g., transition to, switch to) the use of a second congestion control behavior on SL.

For example, the Uu characteristics may include an amount of data being sent on SL versus Uu. For example, a WTRU may use (e.g., switch to) a second congestion control behavior after using a first congestion control behavior in a case where the ratio of data set on SL versus Uu meets a condition. For example, a condition may be determined to be met based on any of the (e.g., configured) split bearer threshold and whether the buffer status is above the current split bearer threshold. For example, in a case where the amount of data routed via the relay link is (e.g., a threshold) more than the amount of data routed via the Uu link, the WTRU may use a second congestion control behavior. For example, in a case where the (e.g., configured) split bearer threshold is above a (e.g., configured) threshold, the WTRU may use (e.g., operate with) the second congestion control behavior.

For example, the congestion control behavior may be determined based on power savings parameters (e.g., expectations, requirements) of the WTRU. For example, whether the WTRU uses a second congestion control behavior, or any of the conditions described above, may further depend on the power savings parameters (e.g., expectations, requirements) of the WTRU. For example, a WTRU with power savings expectations may use the second congestion control behavior. For example, a WTRU with power savings expectations may have more relaxed conditions related to initiating the use of a second congestion control behavior compared to another WTRU with no power savings expectations. For example, a WTRU may receive, from the network, information indicating that the WTRU may be allowed to have power savings expectations. A WTRU may receive from upper layers an indication of power savings expectations and may transmit information to the network indicating the (e.g., new updated) power savings expectations.

### Examples of Congestion Control Behaviors

In various embodiments, a (e.g., first and/or second) set of congestion control parameters may include any of (i) a modulation and coding scheme, (ii) a transmit power, (iii) a channel occupancy ratio, and (iv) a number of retransmissions associated with a range of sidelink channel busy ratio.

A congestion control behavior (e.g., operating mode) according to any embodiment described herein may include any combination of the following examples.

In a first example, a congestion control behavior may comprise any of enabling and disabling any of the (e.g., current) congestion parameters on SL. For example, the WTRU may any of enable and disable congestion control for relayed data based on the Uu characteristics.

In a second example, a congestion control behavior may comprise using a different (set of) congestion control parameters for relayed data. For example, the WTRU may use a first set of congestion control parameters for relayed data and a second set of congestion control parameters for non-relayed data. For example, any of the modulation and coding scheme (MCS), the transmission (Tx) power, the channel occupancy ratio (CR), the number of retransmissions, etc. for a (e.g., given) range of CBR may have different values for relayed versus non-relayed data.

In a third example, a congestion control behavior may comprise using different congestion control parameters for transmissions associated with different bearers. For example, the WTRU may use a first set of congestion control parameters for transmissions of first data on SL, wherein the first data may be associated with any if a first bearer and a first set of bearers, and the WTRU may use a second set of congestion control parameters for transmissions of second data on SL, wherein the second data may be associated with any of a second and a second set bearers.

In a fourth example, a congestion control behavior may comprise any of enabling, disabling and using one or more (e.g., different) congestion control parameters (e.g., only) for specific parameters. For example, only a subset of the congestion control parameters (e.g., any of MCS only, maximum number of retransmissions only, etc.) may be any of enabled, disabled and used.

In a fifth example, a congestion control behavior may comprise applying a different measure of CBR to determine the CBR range for the applicable congestion control parameters. For example, a WTRU may apply any of a first CBR measurement (e.g., determined on a first pool, determined for a first time period, etc.) and a second CBR measurement. For example, the WTRU may apply or not apply a (e.g., configured) offset to the measured CBR.

### Examples of LCHs Restriction Based on Congestion Control Parameters

In an embodiment, a WTRU may be configured with a first set of LCHs that may use (e.g., be associated with) a first congestion control behavior, and a second set of LCHs that may use (e.g., be associated with) a second congestion control behavior. For example, the WTRU may enable a logical channel prioritization (LCP) restriction associated with any of the first set of LCHs and the second set of LCHs. For example, in a case where a grant is used to include data of a LCH from the first set, the WTRU may include (e.g., only) data from the first set into the same grant (and/or vice versa). For example, in a case where the WTRU transmits data of a LCH from the first set of LCHs based on a first grant, the WTRU may transmit only data of the first set of LCHs (e.g., and no data of the second set of LCHs) based on the first grant. For example, in a case where the WTRU selects a first grant for transmitting data from the LCH associated with the first congestion control behavior, the WTRU may then select (e.g., only) data from the LCHs associated with the first congestion control behavior (e.g., for transmission) into (e.g., based on) the same first grant. For example, (e.g., first/second) data may be associated with a (e.g., first/second) grant for (e.g., first/second) transmissions, and the (e.g., first/second) transmissions associated with the (e.g., first/second) grant may be restricted to transmissions of a (e.g., first/second) group of logical channels associated with a (e.g., first/second) congestion control behavior.

For example, a WTRU may apply a LCH restriction (e.g., on SL) after an occurrence of a (e.g., quality deterioration) event on Uu according to any embodiment described herein. For example, before the occurrence of the (e.g., quality deterioration) event (e.g., such as a Uu RLF), the WTRU may use a first congestion control behavior for (e.g., all) transmissions on SL e.g., associated with multipath. For example, after the occurrence of the (e.g., quality deterioration) event (e.g., such as a Uu RLF), the WTRU may be allowed to perform transmissions with a second congestion control behavior for a subset of the LCHs (e.g., only). For example, the WTRU may at that time enable a LCH restriction such that (e.g., only) LCHs that may allow the use of (e.g., that may be associated with) the second congestion control behavior may be multiplexed into (e.g., based on) a grant with any data configured to use (e.g., allow) the second congestion control behavior. For example, the WTRU may use a second congestion control behavior for transmitting a transport block (TB) in a case where the TB includes data (e.g., only) from the LCHs associated with (e.g., which may allow the use of) the second congestion control behavior.

### Example of Congestion Control in Multipath SL Relaying

In an embodiment, a remote WTRU may be configured with a split bearer on multipath (e.g., one path via Uu and one relayed path via SL). For example, the WTRU may transmit first data on a path (e.g., link) to a base station and on a SL path (e.g., link) to a relay WTRU. For example, the WTRU may be configured with a first set of congestion control parameters (e.g., normal set to be used under normal conditions), and a second set of congestion control parameters (e.g., to be used in a case where a quality deterioration is detected on the (e.g., Uu) link to the base station). For example, the WTRU may monitor for a quality deterioration (such as e.g., an Uu RLF) via the direct Uu path. For example, in a case where no quality deterioration is detected (e.g., the quality of the direct Uu path satisfies a quality condition, the Uu path is not in RLF), the WTRU may use the first set of congestion control parameters e.g., for multipath transmissions. In a case where a quality deterioration is detected (e.g., Uu RLF) on the link to the base station, the remote WTRU may move (e.g., all) traffic for split bearers to the relayed path via sidelink. For example, in a case where a quality deterioration is detected on the link to the base station (e.g., Uu RLF), the remote WTRU may operate with (e.g., start using) the second set of congestion control parameters for transmission on sidelink. For example, the WTRU may further limit (e.g., restrict) the use of the second set of congestion control parameters (e.g., only) to transmissions associated with bearers for which duplication may be configured (e.g., enabled). For example, the WTRU may further limit (e.g., restrict) the use of the second set of congestion control parameters (e.g., only) to transmissions from bearers configured to use the second set of congestion control parameters. For example, a transmission from a bearer configured to use the second set of congestion control parameters may include information such as a flag indicating that the second set of congestion control parameters may be used. In another example, the second set of congestion control parameters may be included (e.g., indicated) in bearer configuration information which may be received by the remote WTRU.

In an embodiment, a remote WTRU may be configured with a split bearer on multipath (one path via Uu and one relayed path via SL). For example, the remote WTRU may be configured with a subset of split bearers which may have primary path configured on Uu (e.g., the link to the base station). For example, the WTRU may perform congestion control on SL based on a set of configured congestion control parameters. In a case where a quality deterioration (e.g., such as LBT failure) occurs (e.g., is detected) on Uu (e.g., the link to the base station), the WTRU may disable congestion control for transmission on SL associated with the subset of split bearers having primary path configured on Uu (e.g., the link to the base station).

### Examples of Using Different Tx Pools for Multipath Data Transmission

In an embodiment, a WTRU may use one or more (e.g., different) subsets of SL resources for transmission of data associated with multipath transmissions. For example, the WTRU may be configured with (e.g., by receiving configuration information indicating) any of a separate Tx pool and one or more different subsets of resources on sidelink for transmission of data associated with multipath transmissions. For example, the WTRU may be configured with (e.g., by receiving configuration information indicating) different (e.g., sets of) congestion control parameters associated with the different pools (where a set of congestion control parameters may be associated with a set of resources for SL transmission). For example, the WTRU may use any (e.g., separate) pool of Tx resources for transmissions based on any condition described herein for using (e.g., different) congestion control parameters.

### Example of Indicating the Presence of Duplication (Multipath) on SL Transmission

In an embodiment, a WTRU may transmit information indicating the presence of any of multipath data and duplicated data on sidelink. For example, any of a relay WTRU and a remote WTRU may determine that data should be indicated as duplicated on sidelink based on methods described herein. For example, data may be associated with a bearer configured for duplication. For example, a relay WTRU may receive information indicating that data may be associated with duplication. For example, a WTRU, include information indicating that data may be duplicated on SL. For example, a WTRU may transmit information indicating multipath-like data (where multipath-like data may relate to any of the conditions for changing the congestion control behavior described herein, such as any of (1) multipath data being duplicated over the two links, (2) multipath data associated with a bearer that may have the primary path on any of Uu and SL, (3) multipath data associated with a bearer where the buffer (e.g., level) may satisfy a condition (e.g., above a threshold), etc.,). For example, information indicating the presence of data duplication may be sent (e.g., included) in sidelink control information (SCI). For example, information indicating the presence of data duplication may be sent by including a SL MAC CE in the transmission on SL. For example, information indicating the presence of data duplication may be sent in a PC5-RRC message (e.g., by any of a remote WTRU and a relay WTRU to respectively any of a relay WTRU and a remote WTRU).

### Example of Congestion Control Behavior Depending on Reception of Multipath-Like Indication

In an embodiment, a (e.g., first) WTRU performing transmission on SL may control its congestion control behavior based on information received from other (e.g., second) WTRU(s) indicating multipath-like transmissions.

In a first example, a (e.g., first) WTRU may perform SL only transmissions (such as e.g., V2X transmissions with no relaying of any Uu data). The (e.g., first) WTRU may change its congestion control behavior based on information received from other (e.g., second) WTRUs indicating the presence of (and information associated with) multipath-like transmissions. For example, the WTRU may determine whether to change its congestion control behavior based on the amount of the indicated multipath transmissions, which may include any of:
the SL resource occupancy (e.g., percentage occupancy), associated with multipath-like transmissions satisfying a condition (e.g., above a threshold);
The CBR calculated based on only multipath-like traffic satisfying a condition (e.g., above a threshold);
The SL resource occupancy (e.g., percentage occupancy), associated with multipath-like transmissions which may have priority satisfying a first condition (e.g., above a first threshold), may satisfy a second condition (e.g., above a second threshold).

Changing the congestion control behavior as described in the first example, may allow to reduce any of the transmit power, the number of resources used, etc., of the SL transmissions not associated with relayed Uu data in a case where the relayed Uu data transmissions should be prioritized (e.g., based on some Uu conditions according to any embodiments described herein).

In a second example, a relay WTRU may receive information e.g., in a PC5-RRC message from another WTRU (e.g., a remote WTRU) that may indicate that one or more SL data bearers may carry data that may be duplicated via multipath by the remote WTRU. For example, the relay WTRU may change the congestion control behavior associated with the indicated SL bearers according to any embodiments described herein. This may enable multi-hop relaying on the SL part of multipath for a remote WTRU. For example, a relay WTRU on the multi-hop relayed path may (e.g., consistently) change the congestion control behavior associated with relayed traffic which may be associated with multipath data.

### Examples of SL CBR Reporting Triggers Depending on Uu Characteristics

In an embodiment, a WTRU may be configured with (e.g., receive configuration information indicating) triggers (e.g., conditions) for reporting SL CBR which may depend on any of the Uu (e.g., and SL) characteristics according to any embodiment described herein.

In an embodiment, the WTRU may determine one or more Uu characteristics according to any embodiment described herein. For example, the one or more Uu characteristics may include any of a RLF, a BFD, a LBT failure, a RSRP, a CQI, a number of consecutive HARQ NACKs, an amount of buffered data at the WTRU, and an amount of data sent over SL versus Uu. The WTRU may determine to transmit SL CBR information to the base station based on the one or more Uu characteristics. Determining to transmit SL CBR information may comprise, for example, any of (i) starting a periodic transmission of SL CBR information, (ii) stopping the periodic transmission of SL CBR information, and (iii) modifying a periodicity of the periodic transmission of SL CBR information based on the one or more Uu characteristics.

In an embodiment, the WTRU may determine one or more SL characteristics of the SL, according to any embodiment described herein. The WTRU may determine to transmit SL CBR information to the base station based on the one or more SL characteristics. Determining to transmit SL CBR information may comprise, for example, any of (i) starting a periodic transmission of SL CBR information, (ii) stopping the periodic transmission of SL CBR information, and (iii) modifying a periodicity of the periodic transmission of SL CBR information based on the one or more SL characteristics.

For example, a WTRU may initiate SL CBR reporting (e.g., may transmit information indication a channel busy ratio) based on the amount of data routed via the SL relayed path. For example, in a case where the amount of data routed to the SL relayed path meets a condition (e.g., is above any of a configured and a predetermined threshold, where the threshold may be 0), the WTRU may initiate SL CBR reporting (e.g., transmission) to the network.

For example, a WTRU may determine the periodicity of SL CBR report transmissions based on the amount of data routed via the SL relayed path.

For example, a WTRU may initiate SL CBR reporting (e.g., may transmit information indicating SL CBR) in a case where the WTRU determines to enable duplication, e.g., for one or more split bearers in multipath.

Any Uu characteristics according to any embodiment described herein for enabling the use of a second congestion control behavior may be used to any of control (e.g., any of initiate and stop) SL CBR reporting, and modify any parameters associated with the reporting (e.g., any of the periodicity of the reports, the (e.g., resource) pools included in the reports, etc.).

### Example of Congestion Control Method in Multipath SL Relaying

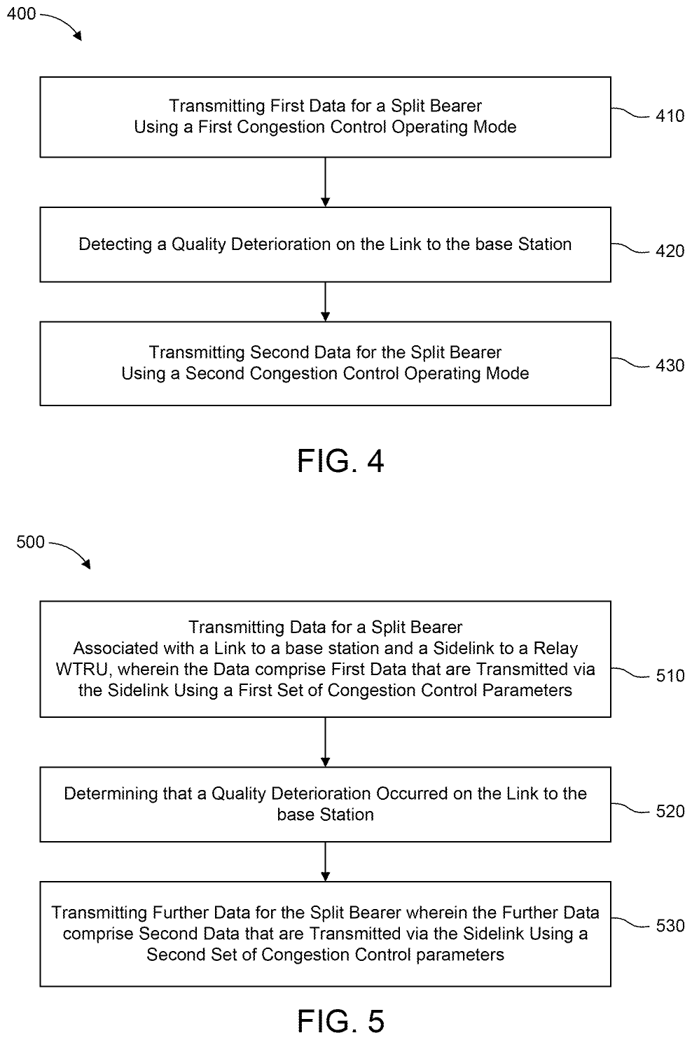

FIG. 4 is a diagram illustrating an example congestion control method 400 in multipath sidelink relaying. In an embodiment, the method 400 may be implemented in a WTRU. As shown at 410, the WTRU may transmit first data for a split bearer via a link to a base station and via a sidelink to a relay WTRU, wherein the first data may be transmitted using a first congestion control operating mode. As shown at 420, the WTRU may detect a quality deterioration on the link to the base station. As shown at 430, the WTRU may transmit second data for the split bearer using a second congestion control operating mode.

In various embodiments, the second congestion control operating mode may be based on a congestion of the sidelink.

In various embodiments, the second congestion control operating mode may comprise performing duplication on the link and the sidelink on condition that a channel occupancy condition is satisfied on the sidelink.

In various embodiments, the channel occupancy condition may be satisfied on the sidelink in a case where a channel busy ratio is below a threshold.

In various embodiments, the second congestion control operating mode may be based on a characteristic of the link to the base station.

In various embodiments, the characteristic of the link to the base station may comprise any of (1) a quality measurement of the link to the base station, (2) a radio link failure of the link to the base station, (3) a beam failure on the link to the base station, (4) a hybrid automatic repeat request feedback characteristic of the link to the base station, (5) an unlicensed spectrum channel access failure, and (6) a buffer status associated with the link to the base station.

In various embodiments, the WTRU may receive signaling information indicating to switch to the second congestion control operating mode.

In various embodiments, the WTRU may switch back to the first congestion control operating mode upon a determination that an amount of time has elapsed after starting to use the second congestion control operating mode.

In various embodiments, the second congestion control operating mode may be used for transmitting the second data on the sidelink to the relay WTRU.

In various embodiments, using the second congestion control operating mode may comprise using different congestion control parameters for relayed data and non-relayed data.

In various embodiments, using the second congestion control operating mode may comprise using different congestion control parameters for transmissions associated with different bearers.

In various embodiments, using the second congestion control operating mode may comprise using different congestion control parameters for transmissions associated with different sets of transmission resources.

In various embodiments, the use of the second congestion control operating mode may be restricted to transmissions associated with a subset of logical channels.

In various embodiments, the use of the second congestion control operating mode may be restricted to transmissions associated with bearers for which duplication may be enabled.

In various embodiments, transmitting the second data using the second congestion control operating mode may comprise duplicating the second data and transmitting information indicating that the second data may be duplicated.

In various embodiments, the WTRU may transmit, to the base station, channel busy ratio information associated with the sidelink based on a characteristic of the link to the base station.

In various embodiments, the WTRU may transmit, to the base station, channel busy ratio information associated with the sidelink, on condition that an amount of data transmitted via the sidelink satisfies a volume condition.

In various embodiments, the volume condition may be met in a case where the amount of data transmitted via the sidelink is above a threshold.

In various embodiments, the channel busy ratio information associated with the sidelink may be transmitted with a periodicity depending on the amount of data transmitted via the sidelink.

FIG. 5 is a diagram illustrating an example method 500 for congestion control in multipath sidelink relaying. The method 500 may be implemented in a WTRU. As shown at 510, the WTRU may transmit data for a split bearer associated with a link to a base station and a sidelink to a relay WTRU. The data may comprise first data that may be transmitted via the sidelink using a first set of congestion control parameters. As shown at 520, the WTRU may determine that a quality deterioration occurred on the link to the base station. As shown at 530, the WTRU may transmit further data for the split bearer. The further data may comprise second data that may be transmitted via the sidelink using a second set of congestion control parameters based on the determining that a quality deterioration occurred on the link to the base station.

In various embodiments, it may be determined that a quality deterioration occurred on the link to the base station in a case where any of a radio link failure, a beam failure detection, and a listen before talk failure occurred on the link to the base station.

In various embodiments, it may be determined that a quality deterioration occurred on the link to the base station in a case where a link quality metric associated with the link to the base station fails to satisfy a quality condition.

In various embodiments, the link quality metric associated with the link to the base station may comprise any of a reference signal receive power and a channel quality indicator. The link quality metric may fail to satisfy the quality condition in a case where the link quality metric is below a first threshold.

In various embodiments, the link quality metric associated with the link to the base station may comprise a number of consecutive hybrid automatic repeat request negative acknowledges received on the link from the base station. The link quality metric may fail to satisfy the quality condition in a case where the number of consecutive hybrid automatic repeat request negative acknowledges is above a second threshold.

In various embodiments, the first set and the second set of congestion control parameters may comprise any of (i) a modulation and coding scheme, (ii) a transmit power, (iii) a channel occupancy ratio, and (iv) a number of retransmissions associated with a range of sidelink channel busy ratio.

In various embodiments, the WTRU may switch back to (e.g., use) the first set of congestion control parameters upon a determination that an amount of time has elapsed after starting to use the second set of congestion control parameters.

In various embodiments, the WTRU may switch back to (e.g., use) the first set of congestion control parameters after receiving signaling information from the base station indicating switching back to the first set of congestion control parameters.

In various embodiments, different congestion control parameters may be used on the sidelink for transmitting relayed data and non-relayed data.

In various embodiments, different congestion control parameters may be used on the sidelink for transmissions associated with different bearers.

In various embodiments, data duplication may be performed on the link to the base station and the sidelink on condition that a channel occupancy condition is satisfied on the sidelink.

In various embodiments, the channel occupancy condition may be satisfied on the sidelink in a case where a channel busy ratio on the sidelink is below a third threshold.

In various embodiments, the WTRU may receive configuration information indicating any of the first set of congestion control parameters and the second set of congestion control parameters.

In various embodiments, the use of the second set of congestion control parameters may be restricted to transmissions associated with bearers for which duplication may be enabled.

In various embodiments, the use of the second set of congestion control parameters may be restricted to transmissions from bearers configured to use the second set of congestion control parameters.

In various embodiments, the WTRU may transmit to the base station channel busy ratio information associated with the sidelink based on a characteristic of the link to the base station.

In various embodiments, the WTRU may transmit to the base station channel busy ratio information associated with the sidelink, based on an amount of data transmitted via the sidelink.

In various embodiments, the second data may be associated with a second grant for second sidelink transmissions, and the second sidelink transmissions associated with the second grant may be restricted to transmissions of a second group of logical channels associated with the second set of congestion control parameters.

In various embodiments, the first data may be associated with a first grant for first sidelink transmissions, and the first sidelink transmissions associated with the first grant may be restricted to transmissions of a first group of logical channels associated with the first set of congestion control parameters.

### Example Method for SL CBR Reporting

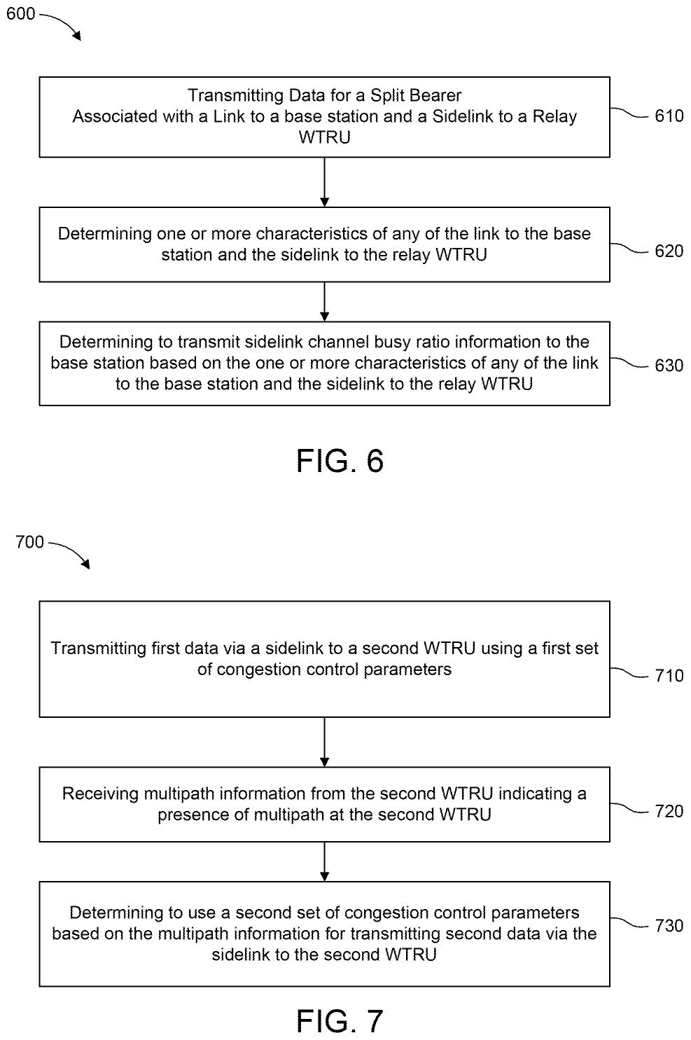

FIG. 6 is a diagram illustrating an example method 600 for SL CBR reporting. The method 600 may be implemented in a WTRU. As shown at 610, the WTRU may transmit data for a split bearer associated with a link to a base station and a sidelink to a relay WTRU. As shown at 620, the WTRU may determine one or more characteristics of any of the link to the base station and the sidelink to the relay WTRU. As shown at 630, the WTRU may determine to transmit sidelink channel busy ratio information to the base station based on the one or more characteristics of any of the link to the base station and the sidelink to the relay WTRU.

In various embodiments, the sidelink channel busy ratio information may be transmitted to the base station periodically.

In various embodiments, determining to transmit sidelink channel busy ratio information may comprise, for example, any of (i) starting a periodic transmission of the sidelink channel busy ratio information, (ii) stopping the periodic transmission of the sidelink channel busy ratio information, and (iii) modifying a periodicity of the periodic transmission of the sidelink channel busy ratio information based on the one or more characteristics of any of the link to the base station and the sidelink to the relay WTRU.

In various embodiments, it may be determined whether to start, stop or modify the periodicity of the periodic transmission of the sidelink channel busy ratio information based on whether a first condition associated with the link to the base station is satisfied or not.

In various embodiments, the first condition may be satisfied in a case where any of a radio link failure, a beam failure detection, and a listen before talk failure occurred on the link to the base station. For example, in a case where of any of a RLF, a BFD and a LBT failure occurs on the link to the base station, the WTRU may stop the periodic transmission of SL CBR information to the base station.

In various embodiments, the first condition may be satisfied in a case where any of a reference signal receive power and a channel quality indicator associated with the link to the base station is below a threshold. For example, in a case where any of a RSRP and a CQI associated with the link to the base station is below a threshold, the WTRU may any of start the periodic transmission of SL CBR information and decrease the periodicity of the periodic transmission (e.g., transmit more frequently).

In various embodiments, the first condition may be satisfied in a case where a number of consecutive hybrid automatic repeat request negative acknowledges received on the link to the base station is above a threshold. For example, in a case where the number of consecutive HARQ NACKs received on the link to the base station is above a threshold, the WTRU may any of start the periodic transmission of SL CBR information and decrease the periodicity of the periodic transmission (e.g., transmit more frequently).

In various embodiments, the first condition may be satisfied in a case where an amount of data buffered at the WTRU is below a threshold. For example, in a case where the of data buffered at the WTRU is below a threshold, the WTRU may any of stop the periodic transmission of SL CBR information and increase the periodicity of the periodic transmission (e.g., transmit less frequently).

In various embodiments, the first condition may be based on an amount of data being sent over the sidelink to the relay WTRU versus the link to the base station. For example, the first condition may be satisfied in a case where the amount of data sent via the sidelink is above (e.g., by a threshold) the amount of data sent via the link to the base station. For example, in a case where the amount of data sent via the sidelink is above (e.g., by a threshold) the amount of data sent via the link to the base station, the WTRU may any of start the periodic transmission of SL CBR information and decrease the periodicity of the periodic transmission (e.g., transmit more frequently).

In various embodiments, it may be determined whether to start, stop or modify the periodicity of the periodic transmission of the SL CBR information based on whether a second condition associated with the sidelink to the relay WTRU is satisfied or not.

In various embodiments, the second condition associated with the sidelink may be satisfied in a case where an amount of data routed via the sidelink is above a threshold.

In various embodiments, it may be determined to start the periodic transmission of the sidelink channel busy ratio information in a case where the amount of data routed via the sidelink is above the threshold.

In various embodiments, it may be determined whether to start or to stop a periodic transmission of the SL CBR information based on whether duplication for the split bearer is enabled or not.

In various embodiments, it may be determined to start the periodic transmission of the SL CBR information based on duplication for the split bearer being enabled.

In various embodiments, a periodicity of transmissions to the base station of the SL CBR information may be based on an amount of data routed via the sidelink.

### Example Method of Congestion Control Behavior Based on Multipath Information

FIG. 7 is a diagram illustrating an example method 700 for changing a set of congestion control parameters based on receiving multipath information. The method 700 may be implemented in a first WTRU. As shown at 710, the first WTRU may transmit first data via a sidelink to a second WTRU using a first set of congestion control parameters. As shown at 720, the first WTRU may receive multipath information from the second WTRU indicating a presence of multipath at the second WTRU. As shown at 730, the WTRU may determine to use a second set of congestion control parameters based on the multipath information for transmitting second data via the sidelink to the second WTRU.

In various embodiments, the multipath information may indicate that a sidelink congestion metric associated with a multipath traffic related to the sidelink satisfies a condition.

In various embodiments, the sidelink congestion metric associated with the multipath traffic may comprise any of sidelink resource occupancy and a percentage of sidelink resource occupancy associated with the multipath traffic. In various embodiments, the condition may be satisfied in a case where the sidelink congestion metric associated with the multipath traffic is above a first threshold.

In various embodiments, the sidelink congestion metric associated with the multipath traffic may comprise a sidelink channel busy ratio based only on the multipath traffic, and the condition may be satisfied in a case where the sidelink congestion metric associated with the multipath traffic is above a second threshold.

In various embodiments, the sidelink congestion metric associated with the multipath traffic may comprise any of a sidelink resource occupancy and a percentage of sidelink resource occupancy associated with transmissions of the multipath traffic having priority. In various embodiments, the condition may be satisfied in a case where the sidelink congestion metric associated with the transmissions of the multipath traffic having priority is above a third threshold.

In various embodiments, the transmissions of the multipath traffic may have priority in a case where the transmissions of the multipath traffic have a priority level above a fourth threshold.

In various embodiments, the second set of congestion control parameters may be determined to reduce a transmit power compared (e.g., relative) to the first set of congestion control parameters.

In various embodiments, the second set of congestion control parameters may be determined to reduce an amount of sidelink resources for transmission compared (e.g., relative) to the first set of congestion control parameters.

Any characteristic, variant or embodiment described for a method is compatible with an apparatus device comprising means for processing any of the disclosed methods, with a device comprising a processor configured to process any of the disclosed methods, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

1. A method implemented in a wireless transmit/receive unit (WTRU), the method comprising:
transmitting data for a split bearer associated with a link to a base station and a sidelink to a relay WTRU, wherein the data comprise first data that are transmitted via the sidelink using a first set of congestion control parameters;
determining that a quality deterioration occurred on the link to the base station; and
transmitting further data for the split bearer, wherein the further data comprise second data that are transmitted via the sidelink using congestion control parameters that are changed from the first set of congestion control parameters to a second set of congestion control parameters based on the quality deterioration having occurred on the link to the base station, wherein the congestion control parameters are used to control congestion of sidelink resources in a distributed scheduling mode.

2. The method of claim 1, wherein determining that the quality deterioration occurred on the link to the base station comprises detecting that any of a radio link failure, a beam failure detection, and a listen before talk failure occurred on the link to the base station.

3-5. (canceled)

6. The method of claim 1, wherein the congestion control parameters comprise any of (i) a modulation and coding scheme, (ii) a transmit power, (iii) a channel occupancy ratio, and (iv) a number of retransmissions associated with a range of sidelink channel busy ratio.

7. The method of claim 1, comprising switching back to the first set of congestion control parameters based on an amount of time having elapsed after starting to use the second set of congestion control parameters.

8. The method of claim 1, comprising switching back to the first set of congestion control parameters after receiving signaling information from the base station indicating switching back to the first set of congestion control parameters.

9. The method of claim 1, wherein different congestion control parameters are used on the sidelink for transmitting relayed data and non-relayed data.

10. The method of claim 1, wherein different congestion control parameters are used on the sidelink for transmissions associated with different bearers.

11. The method of claim 1, comprising performing data duplication on the link to the base station and the sidelink on condition that a channel occupancy condition is satisfied on the sidelink.

12. The method of claim 11, wherein the channel occupancy condition is satisfied on the sidelink in a case where a channel busy ratio on the sidelink is below a threshold.

13. The method of claim 1, comprising receiving configuration information indicating any of the first set of congestion control parameters and the second set of congestion control parameters.

14. The method of claim 1, wherein the use of the second set of congestion control parameters is restricted to transmissions associated with bearers for which duplication is enabled.

15. The method of claim 1, wherein the use of the second set of congestion control parameters is restricted to transmissions from bearers configured to use the second set of congestion control parameters.

16-17. (canceled)

18. A wireless transmit/receive unit (WTRU) comprising circuitry, including a transmitter, a receiver, a processor, and a memory, configured to:
transmit data for a split bearer associated with a link to a base station and a sidelink to a relay WTRU, wherein the data comprise first data that are transmitted via the sidelink using a first set of congestion control parameters;
determine that a quality deterioration occurred on the link to the base station; and
transmit further data for the split bearer, wherein the further data comprise second data that are transmitted via the sidelink using congestion control parameters that are changed from the first set of congestion control parameters to a second set of congestion control parameters based on the quality deterioration having occurred on the link to the base station, wherein the congestion control parameters are used to control congestion of sidelink resources in a distributed scheduling mode.

19. The WTRU of claim 18, wherein the first data are associated with a first grant for first sidelink transmissions, and wherein the first sidelink transmissions associated with the first grant are restricted to transmissions of a first group of logical channels associated with the first set of congestion control parameters.

20. The WTRU of claim 18, wherein the congestion control parameters comprise any of (i) a modulation and coding scheme, (ii) a transmit power, (iii) a channel occupancy ratio, and (iv) a number of retransmissions associated with a range of sidelink channel busy ratio.

21. The WTRU of claim 18, wherein the second data are associated with a second grant for second sidelink transmissions, and wherein the second sidelink transmissions associated with the second grant are restricted to transmissions of a second group of logical channels associated with the second set of congestion control parameters.

22. The WTRU of claim 18, configured to switch back to the first set of congestion control parameters based on an amount of time having elapsed after starting to use the second set of congestion control parameters.

23. The WTRU of claim 18, configured to switch back to the first set of congestion control parameters after receiving signaling information from the base station indicating switching back to the first set of congestion control parameters.

24. The method of claim 1, wherein the first data are associated with a first grant for first sidelink transmissions, and wherein the first sidelink transmissions associated with the first grant are restricted to transmissions of a first group of logical channels associated with the first set of congestion control parameters.

25. The method of claim 1, wherein the second data are associated with a second grant for second sidelink transmissions, and wherein the second sidelink transmissions associated with the second grant are restricted to transmissions of a second group of logical channels associated with the second set of congestion control parameters.
